(19) United States
(12) Patent Application Publication
(10) Pub. No.: US 2013/0098798 A1
(43) Pub. Date: Apr. 25, 2013

(54) PIPE TRANSPORT SYSTEM

(71) Applicants: Gregory John Hatton, Houston, TX (US); Ajay Praful Mehta, Houston, TX (US); Chien Kuei Tsai, Katy, TX (US)

(72) Inventors: Gregory John Hatton, Houston, TX (US); Ajay Praful Mehta, Houston, TX (US); Chien Kuei Tsai, Katy, TX (US)

(21) Appl. No.: 13/805,744

(22) PCT Filed: Jun. 21, 2011
(86) PCT No.: PCT/US2011/041168

§ 371 Date: Dec. 20, 2012

Related U.S. Application Data
(60) Provisional application No. 61/357,794, filed on Jun. 23, 2010.

(51) Int. Cl. B65D 25/14; E21B 17/01; F16L 9/00; E21B 43/01

(52) U.S. Cl. CPC B65D 25/14; E21B 43/01; E21B 17/01; F16L 9/00
USPC 206/524.3; 166/335; 138/145

(57) ABSTRACT

A non-stick apparatus, comprising a fluid-solids stream storage or conveyance article comprising a first material; a coating on an internal surface of the article comprising a second material; wherein the second material comprises a reduced adhesion strength with a wax deposit of less than 30% of a first material adhesion strength with a wax deposit.

### BACKGROUND OF INVENTION

1. Field of the Invention

There are disclosed fluid-solids stream storage and conveyance articles with an improved non-stick coating.

2. Background Art

Various coatings and other surface treatments have been applied to the internal and external surfaces of pipes, tanks, and other liquid storage and conveyance articles.

U.S. Patent Publication No. 2006/0186023 discloses a method of transporting a produced fluid through a pipe while limiting deposits at a desired pipe inner-wall location comprising providing a pipe having an inner surface roughness Ra less than 2.5 micrometers at said desired pipe inner-wall location, forcing the produced fluid through the pipe, wherein the produced fluid has a wall shear stress of at least 1 dyne per centimeter squared at said desired pipe inner-wall location. U.S. Patent Publication No. 2006/0186023 is incorporated herein by reference in its entirety.

U.S. Pat. No. 7,300,684 discloses the coating of internal surfaces of a workpiece is achieved by connecting a bias voltage such that the workpiece functions as a cathode and by connecting an anode at each opening of the workpiece. A source gas is introduced at an entrance opening, while a vacuum source is connected at an exit opening. Pressure within the workpiece is monitored and the resulting pressure information is used for maintaining a condition that exhibits the hollow cathode effect. Optionally, a pre-cleaning may be provided by introducing a hydrocarbon mixture and applying a negative bias to the workpiece, so as to sputter contaminants from the workpiece using argon gas. Argon gas may also be introduced during the coating processing to re-sputter the coating, thereby improving uniformity along the length of the workpiece. The coating may be a diamond-like carbon material having properties which are determined by controlling ion bombardment energy. U.S. Pat. No. 7,300,684 is incorporated herein by reference in its entirety.

Co-pending PCT Patent Application PCT/US2010/020420 discloses a non-stick apparatus, comprising a liquid storage or conveyance article comprising a first material; a coating on an internal surface of the article comprising a second material; wherein the second material comprises a critical surface tension value less than 75 mN/m and a hardness value of at least 5 measured on a Moh's scale. PCT Patent Application PCT/US2010/020420 is incorporated herein by reference in its entirety.

Deposits of wax and/or hydrate can, along with agglomeration of solids in the flow, lead to blockage of flow in a production/transportation system. To avoid this, the system may be insulated and the production treated. With insulation, heat loss from the transported stream is reduced. If the stream temperature can be maintained sufficiently high, then deposits may be avoided. If the stream is chemically treated, then the temperature at which deposits occur may be reduced. If the deposit temperature is below the stream temperature, then deposits may be avoided. By using either of these methods, insulation or chemical treatment (or combination thereof), deposits can be prevented. However, these methods of preventing deposits can be very costly.

There is a need in the art for non-stick, improved, lower cost, and/or alternative coatings for the internal surfaces of fluid-solids stream storage and conveyance articles.

### SUMMARY OF THE INVENTION

One aspect of invention provides a non-stick apparatus, comprising a fluid-solids stream storage or conveyance article comprising a first material with a coating on an internal surface of the article that reduces the adhesion strength with a wax deposit to less than 30% of the adhesion strength without a coating.

Another aspect of invention provides coatings to prevent deposits on pipes, tanks, and vessels.

Advantages of the invention include one or more of the following:

Improved non-stick coatings for pipes and tanks;

Lower cost non-stick coatings for pipes and tanks; and/or

Alternative non-stick coatings for pipes and tanks.

### BRIEF DESCRIPTION OF THE DRAWINGS

FIG. 1 shows a precipitate particle bonded to the inner surface of a piece of production/transportation equipment in accordance with embodiments disclosed herein.

FIG. 2 illustrates the relationship between bonding force and distance between a hydrate particle and a conductor.

### DETAILED DESCRIPTION

In one aspect, embodiments disclosed herein relate generally to plasma generated coatings provided on one or more surfaces of equipment used in fluid transport systems. More specifically, embodiments disclosed herein relate to methods of modifying an inner surface of production and/or transportation equipment to inhibit the formation of deposits thereon and prevent such deposits from blocking the flow of fluid through the equipment.

As used herein, the term “deposit” is used to refer to precipitates or solids in production fluids, such as waxes, asphaltenes, hydrates, organic salts, and inorganic salts. Such deposits are known to clog and/or damage equipment such as subsea pipes and risers used in oil and gas production as well as production tubing used in standard production wells. Waxes, or high molecular weight paraffins, found in production systems generally include branched and straight, high carbon number (average carbon numbers of 18+) alkane hydrocarbon chains. Asphaltene is defined as the fraction of the crude oil, bitumen, or coal, insoluble in n-heptane, but soluble in toluene. Electromagnetic forces and pipe-wall topological characteristics may contribute to the “bonding” of deposits (e.g., wax, asphaltene, or hydrate particles) to the pipe inner wall.

Hydrates are crystal solids comprised of water and guest molecules small enough to fit within the crystal cages—e.g., methane, ethane, and propane. Specifically, hydrate crystals generally have ten electrons that occupy the orbitals of each oxygen-hydrogen pair, i.e., two electrons in the oxygen 1 s orbital and eight electrons in the 4 oxygen sp³ orbitals. The outer hydrate crystal surface is covered by outward protruding sp³ orbitals with and without hydrogen nuclei. As viewed from outside the hydrate crystal, the hydrate crystal surface is covered with electrical dipoles. That is, from outside of the hydrate crystal, the outer hydrate crystal surface appears to be covered with local regions of positive charge and of negative charge. This local positive charge and negative charge outer crystal surface may form a strong bond with a close conductor (e.g., a steel pipe wall). However, the bond with a distant conductor may be significantly weaker.

Asphaltenes are complex hydrocarbon molecules that can contain carbon, hydrogen, nitrogen, oxygen, and sulfur, and often have dipole moments. The inorganic salts may include any inorganic salt typically present in produced streams and which may precipitate to form salt deposits known as scale. Such inorganic salts include sulfates (e.g., BaSO₄, CaSO₄, and SrSO₄) and carbonates (e.g., CaCO₃, MgCO₃, and FeCO₃) as well as more common chlorides of sodium, calcium, and magnesium. A salt is generally an ionic complex between a positively charged cation and a negatively charged anion. An organic salt is a salt that contains a carbon-containing cation.

Initially, solids such as those mentioned above may be dissolved in production fluids; however, some of the dissolved solids may be caused to solidify and/or precipitate out of solution as thermodynamic parameters change, for example, as temperature and/or pressure change. For example, the solubility of wax decreases as temperature and pressure decrease. Similarly, salt solubility changes with a decrease in temperature and pressure. Asphaltenes generally form in response to a decrease in pressure. Hydrate deposits typically form at reduced temperatures and high pressures. Further, some of the dissolved solids may precipitate out of solution as chemical composition parameters change, such as composition changes caused by the mixing of two or more streams. For example, hydrates may precipitate when mixed with fresh water, asphaltene precipitation may be induced by the addition of lower paraffins, and salts may precipitate due to incompatibilities that result when multiple brines are mixed.

Subsea flowlines or conduits used to transport oil, gas, and aqueous fluids from a well to a host facility for fluid separation and treatment generally combine fluids from several wells or even several fields (i.e., several different fluids are mixed). These flowlines or conduits are typically very cold (i.e., near the freezing point of water), for example less than 50 or less than 40 degrees F. When cooling occurs in a flowing pipeline, well, or conduit, the formation of waxy or paraffinic, hydrate, asphaltenic, and salt solids is undesirable, as the solids build up in the conduit by partially depositing onto the walls and/or settling to the bottom, thereby reducing the flow cross-sectional area and eventually leading to spalling of the deposit and plugging of the pipeline. This may result in shut-in of the line and temporary cessation of well production. A buildup is usually caused by a deposition process where the solids form on the system walls and continue to grow so as to obstruct the system or conduit.

Typically, the solids deposition on the flow line inner wall continues as long as the fluid temperature is greater than the wall “surface” temperature the fluid contacts, there is flow, and the pressure and temperature are conducive for solid formation. Isothermal conditions typically do not lead to deposition but still may induce limited solids formation (due to sub-cooling effects) and gravitational drop out when flow is stopped. In general, it is recognized that solids that settle as flow is stopped are unlikely to form true deposits but rather tend to be removed as flow is reinitiated. Any buildup of solids reduces the cross-sectional area for flow or the volume through the flow line, which can lead to reduced throughput and eventual total obstruction. Thus, embodiments of the present disclosure provide systems and methods for assuring maximal or unobstructed passage of fluid through a flow line, such as a pipeline or conduit.

Generally, embodiments of the present disclosure relate to systems and methods for modifying the inner surfaces of production and/or transportation equipment by depositing a coating thereon to which deposits have a very weak attraction and thus do not occur at moderate and high transport rates. In one embodiment, the modified (i.e., coated) equipment may inhibit deposits from forming on an inner surface of a tubular structure (e.g., conduit, pipe, tube, flowline, etc.) by minimizing the atomic attraction between the inner surface of the tubular structure and the positive and negative charges located on the surfaces of the wax or hydrate crystals.

Various techniques for depositing a coating on the desired surface(s) of the production/transportation equipment may be used. For example, glow discharge deposition may be used to form a substantially uniform coating on the inner surface of a tubular structure (e.g., conduit, pipe, tube, flowline, etc). Specifically, an electo-magnetic field enhanced plasma deposition technique known as plasma enhanced chemical vapor deposition (PE-CVD) may be used in forming coatings of the present application.

The production/transportation equipment of the present disclosure may be comprised of substantially any material. In one embodiment, the equipment may be made of steel or of a corrosion-resistant alloy (CRA). Using PE-CVD, the coating may be applied to the desired surface(s) of the equipment at relatively low temperatures, making the procedure useful for coating both thermally sensitive materials, such as carbon steels and polymers, as well as materials that can withstand higher temperatures, such as ceramics, and other metal alloys. Depending on the applied voltage and pulse frequency, coatings may be applied and/or formed at temperatures as low as about 100° C. or as high as about 500° C.

In order to use PE-CVD to apply the coating, the inner surface(s) of the equipment (e.g., a tubular structure such as a pipe or conduit) may first be cleaned to remove any superficial contaminants. Additionally, depending on what material the surface to be coated is comprised of, it may need to be treated with an intermediate material so as to form a bonding gradient between the surface to be coated and a gaseous precursor material for the coating. Then, the equipment (e.g., the pipe or conduit) is placed in an electro-magnetic field. The entire setup is then placed in a vacuum chamber, which is subsequently backfilled with an inert gas, or alternatively, a vacuum may be created inside the pipe to be coated, and the inside of the pipe is then filled with an inert gas. A pulse frequency is then applied to bias the equipment to at least about 200V for a duration necessary to deposit a coating having the desired thickness.

Coatings in accordance with the present disclosure include any coating that may be applied using techniques such as those disclosed herein. For example, in one embodiment of the present disclosure, the coating may be any of the following: amorphous carbon coatings, diamond-like-carbon coatings, metallic coatings, silicon coatings, fluorinated coatings, ceramic coatings, and any material than can be deposited from a plasma, including, for example, oxides, carbides, and nitrides. To form an amorphous carbon film, a hydrocarbon gas, such as CH₄ or C₂H₂, may be used. To form a metallic or ceramic coating, an organometallic gas, such as Cr—, Al—, or Ti-containing precursors, may be used.

In one embodiment of the present disclosure, a method of inhibiting deposits from forming on an inner surface of a conductor (i.e., equipment, conduit, pipe, tube, flowline, etc.) includes depositing a coating on an inner surface of the conductor wherein the coating is comprised of a non-conducting material capable of minimizing the attraction between the conductor and the deposits (e.g., by increasing the distance between them and by having a low dielectric value and surface energy). Specifically, the method of inhibiting deposit formation may include depositing a layer of the non-conducting material on the inner surface of the conductor, and flowing a flowable mixture through the equipment at a moderate or high transport rate, wherein the flowable mixture has dissolved solids therein, and wherein the dissolved solids may precipitate out of the flowable mixture to form precipitates that are comprised of at least one of the following: wax, asphaltene, hydrate, organic salts, inorganic salts, and combinations thereof. The deposited layer of non-conductive material on the inner surface of the conductor reduces the attraction of dissolved solids and/or precipitates to the inner surface of the conductor, thereby reducing deposit formation on the inner surface of the conductor (i.e., the inner wall of a conduit, pipe, flowline, etc.) The desired coatings have low surface adhesion with the target deposits. The best coating for one type of deposit is not necessarily the best for another type of deposit, but generally the best coatings for the deposits of interest here (wax, asphaltene, hydrate, organic salts, inorganic salts, and combinations thereof) are low dielectric, low surface energy coatings. Such coatings are relatively inert material. The coating should also be resistant to wear.

As discussed above, it is undesirable for precipitates of production fluids, such as waxes, asphaltenes, hydrates, organic salts, and inorganic salts, to deposit on or to the inner surface(s) of equipment used in production and/or transportation of hydrocarbons and/or drilling fluids. However, the occurrence of this “bonding” does not occur simply due to the presence of the deposits in the pipeline. Rather, it may be attributed to interactions that occur between the precipitate particles and characteristics of the equipment itself. For example, electromagnetic forces present in the equipment and capable of interacting with the exposed charges on the precipitate particles may contribute to the presence of deposits in a pipeline.

Additionally, the topological characteristics of the inner surfaces of the pipeline, the flow rate or velocity by which fluids are passed through the pipeline, and the thermal conductivity of the pipeline or any materials used to coat the pipeline may contribute to the presence of deposits therein. According to one embodiment of the present disclosure, an inner surface of a steel conduit may be coated with a material capable of inhibiting deposit formation at mixture flow-velocities of more than 2 feet/second. In another embodiment, the material used to coat the inner surface of the steel conduit may have a thermal conductivity that is from about 0.05 times that of steel to about 0.25 times that of steel. For example, carbon steels may have a thermal conductivity in a range of about 19-31 Btu/(hr ° F. ft) (32-54 W/mK), and therefore a coating used in accordance with embodiments disclosed herein may have a thermal conductivity in a range of about 1-16 Btu/(hr ° F. ft) (1.6-27 W/mK). The material used to coat the inner surface of the flowline may remain intact and still reduce or inhibit deposit formation on the inner surface even in the pipeline is pigged.

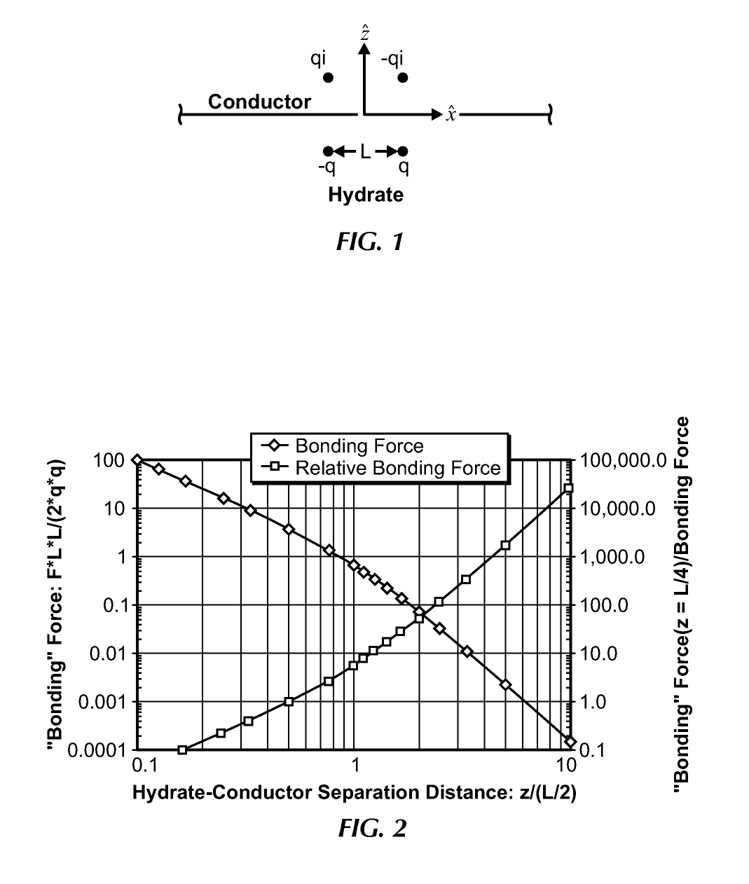

FIG. 1:

FIG. 1 demonstrates qualitatively the “bonding” of a precipitate particle to the inner surface of a piece of production/transportation equipment. Specifically, FIG. 1 shows a hydrate particle having two neighboring charges q and −q (one positive and one negative) on its outer crystal surface that are separated by distance L. The boundary condition of a plane conductor at the pipe wall-pipe interior can be exactly satisfied by proper location of image charges qi and −qi in the conductor where qi=q. The electric field potential, V^{q} at the location of charge q is shown by Equation 1.

$${V}^{q} = - q ( \frac{1}{2 z} + \frac{1}{L} - \frac{1}{{( {L}^{2} + {( 2 z )}^{2} )}^{\frac{1}{2}}} ) \qquad Equation 1$$

The force on charge q in the z direction, F_{z}^{q}, is shown by Equation 2.

$$\begin{matrix}{F}_{z}^{q} = - q \frac{\partial {V}^{q}}{\partial z} \\ = \frac{2 {q}^{2}}{{L}^{2}} {( \frac{L}{2 z} )}^{2} ( 1 - \frac{1}{{( 1 + {( \frac{L}{2 z} )}^{2} )}^{\frac{3}{2}}} )\end{matrix} \qquad Equation 2$$

FIG. 2:

The force on charge −q in the z direction has the same magnitude and sign, as shown by Equation 2. The dimensionless force F_{z}^{q}L²/(2q²) is shown as a function of L/(2z) in FIG. 2. As the scaled hydrate-conductor distance varies from 0.1 to 10, the dimensionless “bonding” force, F_{z}^{q}L²/(2q²), varies over 6 orders of magnitude from 100 to about 0.0001. However, in accordance with embodiments of the present disclosure, a non-conducting layer may be deposited on the inner surface of the conductor to increase the distance between the hydrate particle and the conductor and thereby decrease the interaction between them. For example, if z (the distance between the hydrate particle and the conductor) is assumed to be

$$\frac{L}{4}$$

without a non-conducting layer, then by adding a non-conducting conducting layer (2.5 L to 5 L in thickness) to the surface, the “bonding” force between the hydrate and the conductor may be decreased by about 1,600 to 25,000.

Advantageously, embodiments of the present disclosure may eliminate or minimize the occurrence of deposit formation in production and/or transportation systems. Specifically, depositing a coating in accordance with embodiments of the present disclosure onto one or more inner surfaces of production and/or transportation equipment may inhibit the formation of deposits thereon and may prevent such deposits from blocking or obstructing the flow of fluid through the equipment. Additionally, embodiments of the present disclosure may also eliminate or reduce the need for chemical injection and/or the need for insulated flowlines, as well as reduce the overall cost generally associated with preventing deposit formation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A non-stick apparatus, comprising:
a fluid-solids stream storage or conveyance article comprising a first material;
a coating on an internal surface of the article comprising a second material;
wherein the second material comprises a reduced adhesion strength with a wax deposit of less than 30% of a first material adhesion strength with a wax deposit.

2. The apparatus of claim 1, wherein the second material comprises an electrical conductivity of less than 25% of a first material electrical conductivity.

3. The apparatus of claim 1, wherein the second material comprises a material selected from the group consisting of amorphous carbon, silicon, ceramics, carbides, nitrides, and polymers.

4. The apparatus of claim 1, wherein the second material comprises a plasma generated coating.

5. The apparatus of claim 1, wherein the second material comprises a hexamethyldisoloxane plasma coating or a fluorinated plasma coating.

6. The apparatus of claim 1, wherein the first material is selected from the group consisting of steel, stainless steel, cast iron, copper, and plastic.

7. The apparatus of claim 1, wherein the second material comprises a polymeric coating.

8. The apparatus of claim 1, wherein the article is a pipe or vessel in a cold flow system.

9. The apparatus of claim 1, wherein the article comprises a pipe.

10. The apparatus of claim 1, wherein the article comprises a tank.

11. A method of producing hydrocarbons, comprising:
drilling a well on a sea floor;
producing hydrocarbon containing fluids to a wellhead on the sea floor;
connecting a pipe from the wellhead to a location on land or a floating production platform or vessel; and
coating an internal surface of the pipe, or the part of the pipe closest to the well, with a material comprising a reduced adhesion strength with a wax deposit of less than 30% of an uncoated pipe adhesion strength with a wax deposit.

12. A method of producing hydrocarbons, comprising:
drilling a well on a sea floor;
producing hydrocarbon containing fluids to a wellhead on the sea floor;
connecting the wellhead stream to a cold flow system and a flowline to a location on land or a floating production platform or vessel; and
coating an internal surface of the cold flow system with a material comprising a reduced adhesion strength with a wax deposit of less than 30% of an uncoated cold flow system surface adhesion strength with a wax deposit.
